(19) United States
(12) Patent Application Publication
(10) Pub. No.: US 2011/0226252 A1
(43) Pub. Date: Sep. 22, 2011

(54) HYPERBARIC THERAPY DEVICE

(76) Inventors: Tom Milne, Seattle, WA (US); Matthew Griffin, Issaquah, WA (US); Andrew Cull, Seattle, WA (US); Chris Kenney, Seattle, WA (US)

(21) Appl. No.: 12/729,118

(22) Filed: Mar. 22, 2010

(51) Int. Cl. A61G 10/02

(52) U.S. Cl. 128/205.26

(57) ABSTRACT

A method and apparatus for treating altitude related illnesses and/or injuries are provided. Example embodiments provide a hyperbaric therapy device (“HTD”) which includes a chamber constructed substantially from a light weight, high strength, substantially air impermeable material, such as a flexible composite laminate material, such that the chamber can maintain an internal air pressure that is higher than ambient air pressure. In some embodiments, an opening in the chamber of the HTD may be sealed by way of a roll-down, dry bag style closure. The chamber of the HTD may also include multiple inflation valves, to support multiple pump systems for efficient inflation and pressure maintenance. The HTD may also include a storage bag that doubles as a pump for inputting air into the chamber of the HTD.

### BACKGROUND

1. Technical Field

The present disclosure relates to the treatment of altitude related illnesses and injuries, and more particularly, to a hyperbaric therapy device and a method for using the device to treat altitude related illnesses and injuries.

2. Description of Related Art

As one gains altitude, the air gets thinner, the pressure is lower, and less oxygen is available in the atmosphere. People who work, travel, or exercise at altitudes significantly above sea level may experience high altitude related illnesses and/or injuries as a result of oxygen deficit and/or other altitude related factors. Altitude related illnesses and injuries include Acute Mountain Sickness (“AMS”), High Altitude Pulmonary Edema (“NAPE”), High Altitude Cerebral Edema (“HACE”), and perhaps others not yet fully understood by the medical community. It is well documented that NAPE and HACE are potentially fatal without effective intervention. Altitude related illnesses and injuries can be treated a number of ways, including via the administration of pharmaceuticals, physical descent in altitude, a “simulated” physical descent in altitude to an ambient atmospheric pressure that is higher than that at which the injury or illness occurred via a hyperbaric chamber or other type of pressurized vessel or chamber, or a combination of all three.

In the 1980s, Dr. Igor Gamow developed the “Gamow Bag.” This inflatable hyperbaric chamber creates a simulated descent for the treatment of altitude related illnesses and injuries. Using a pump to inflate the bag to an internal pressure that is greater than the ambient atmospheric pressure at the patient's physical altitude (thereby creating an artificial lower altitude), a patient inside the Gamow Bag can experience an immediate simulated descent of several thousand feet. Generally, an individual needs to physically descend 1,000 to 3,000 feet to see AMS conditions improve—a potentially impossible situation due to weather, terrain, rescuer assets on hand, or tactical considerations. A pressurized chamber enables improvement with no descent or transport, and pressure can be maintained by the rescuers via the pump. In an environment or conditions where descent is not an option, a hyperbaric chamber is critical to maintain operator effectiveness for mission completion. Thus, the Gamow Bag represents an important evolution in altitude related illness treatment.

However, the Gamow bag and other conventional pressurized chambers do have some limitations. One example pressurized chamber weighs about 15 pounds and has a volume of about 2900 cubic inches. As such, these chambers are often too heavy and/or bulky to carry to high altitude. Also, known pressurized chambers utilize manual (foot) pumps and can thus be tiring for the operator. Further, known pressurized chambers can be awkward to carry in conjunction with a litter, due to a lack of suitable strap system.

### SUMMARY

In one embodiment, a hyperbaric therapy device is provided. The hyperbaric therapy device includes a chamber large enough to contain an adult human patient, the chamber constructed substantially from a material that is substantially impermeable to air, such that the chamber can maintain an internal air pressure that is higher than ambient air pressure, wherein the chamber includes an opening large enough to permit passage of the adult human patient; a roll-down closure comprising a first fastener, the closure operable to seal the opening by rolling material of the chamber, and securing the rolled material in position with the first fastener; a first inflation valve coupled to the chamber and operable to, when connected to a pump system, inflate the chamber to the internal air pressure; and a pressure relief valve coupled to the chamber and operable to, when the internal air pressure exceeds a predetermined maximum air pressure, release air from the chamber.

In another embodiment, a hyperbaric therapy device includes a chamber large enough to contain an adult human patient, the chamber constructed substantially from a material that is substantially impermeable to air, such that the chamber can maintain an internal air pressure that is higher than ambient air pressure; a first inflation valve coupled to the chamber and operable to, when connected to a pump system, inflate the chamber to the internal air pressure; a second inflation valve of a type that is different from a type of the first inflation valve, the second inflation valve coupled to the chamber and operable to, when connected to a pump system, inflate the chamber to the internal air pressure; and a pressure relief valve coupled to the chamber and operable to, when the internal air pressure exceeds a predetermined maximum air pressure, release air from the chamber.

In a further embodiment, a hyperbaric therapy device includes a chamber large enough to contain an adult human patient, the chamber constructed substantially from a flexible composite laminate material that is substantially impermeable to air, such that the chamber can maintain an internal air pressure that is higher than ambient air pressure; a first inflation valve coupled to the chamber and operable to, when connected to a pump system, inflate the chamber to the internal air pressure; and a pressure relief valve coupled to the chamber and operable to, when the internal air pressure exceeds a predetermined maximum air pressure, release air from the chamber, wherein the hyperbaric therapy device has a mass of not more than 5 kilograms and a compressed volume of not more than 10 liters.

In another embodiment, a method for treating altitude related illnesses and/or injuries is provided. The method includes deploying the described hyperbaric therapy device; causing a human patient to enter the chamber of the hyperbaric therapy device via the opening in the chamber; sealing the opening in the chamber using a roll-down closure; inflating the chamber to an internal air pressure higher than ambient pressure; and maintaining the internal air pressure higher than ambient pressure for an effective period of time.

### BRIEF DESCRIPTION OF THE DRAWINGS

The components in the drawings are not necessarily to scale relative to each other. Like reference numerals designate corresponding parts throughout the several views.

FIGS. 1A-1C are various views of one embodiment of a hyperbaric therapy device.

FIGS. 2A-2D are various views of example embodiments of a hyperbaric therapy device.

FIGS. 3A-3D are additional views of example embodiments of a hyperbaric therapy device.

FIGS. 4A-4C are further views of example embodiments of a hyperbaric therapy device.

FIG. 5 is a flow diagram of a process for treating altitude related illnesses and/or injuries.

### DETAILED DESCRIPTION

Embodiments described herein provide a hyperbaric therapy device (“HTD”). The HTD can be used to treat altitude related illnesses and/or injuries and other conditions. The HTD includes a chamber that is constructed substantially from a flexible composite material that provides high strength (e.g., breaking strength, rip stop) at a very low weight, such that one example HTD weighs less than 1.5 kg. In addition, the HTD is highly packable, compressing when deflated and packing to a volume of less than five liters. In some embodiments, the HTD includes multiple inflation valves of different type, such that the chamber of the HTD can be inflated using a variety of pump systems.

These and other features of the HTD, discussed in more detail below, address some of the issues presented by existing hyperbaric chambers. In particular, existing hyperbaric chambers weigh between 15 to 35 pounds (about 7 to 16 kg) with a pack size of about 2900 cubic inches (over 45 liters). Unfortunately, the relatively high weight of existing hyperbaric chambers can be a contributor to the very problems they were meant to resolve. More specifically, the amount of effort required by operators at high altitude to function, much less carry equipment, is dramatically higher than at lower elevations. This increased exertion required of operators at high altitude can contribute to susceptibility of altitude related illnesses and/or injuries and/or exacerbate the symptoms of altitude related illnesses and/or injuries. Thus, operators at high altitude are typically fastidious about excess weight—ounces and even grams trimmed from packs and other gear can yield great benefits. Operators at high altitude are typically also fastidious about excess bulk, because backpacks place a hard limit on the volume of gear that can be carried. Although the current hyperbaric chambers may be effective for treating altitude related illnesses and/or injuries, they are rarely carried to high altitude (e.g., beyond base camp) as they are far too heavy and bulky to merit inclusion in an already trimmed-down pack. Furthermore, “speed is safety” at high altitude and other mountain settings. Climbers and other operators should minimize their time exposed to various hazards, such as falling rocks, ice, inclement weather, and the like. A requirement to carry an additional 20 or more pounds of gear would cause a climber to travel more slowly and thus further expose the climber to objective hazards, such as ice fall, storms, and the like. The lightweight, packable qualities of the HTD address many of the deficiencies that are typically associated with existing hyperbaric chambers.

An unexpected result of the HTD is the dramatic increase in usability and applicability in a wide variety of environments. In particular, operators such as climbers or military users are highly unlikely to carry existing hyperbaric chambers to the very places that those chambers will provide the greatest benefit—high altitude. At high altitude, operators typically must carry everything on their backs, because vehicular support is limited (e.g., because there are no roads for trucks, helicopters do not perform well at high altitude). Given a typical backpack with a maximum volume of 8,000 cubic inches, and requirements to carry food, clothing, and other equipment (e.g., climbing equipment, weapons systems, communications systems), a high altitude operator simply cannot afford the addition of a 3,000 cubic inch hyperbaric chamber. Many deaths from high altitude related illness/injury on Mt. Everest have occurred above base camp, while a hyperbaric chamber was situated at base camp, because the chamber was not (or could not be) carried to the site of the injury due to weight, bulk, and/or time. Thus, the negligible volume and weight of the HTD will results in increased inclusion as part of the standard kit of a high altitude operator, resulting in a decrease in injury or death caused by high altitude.

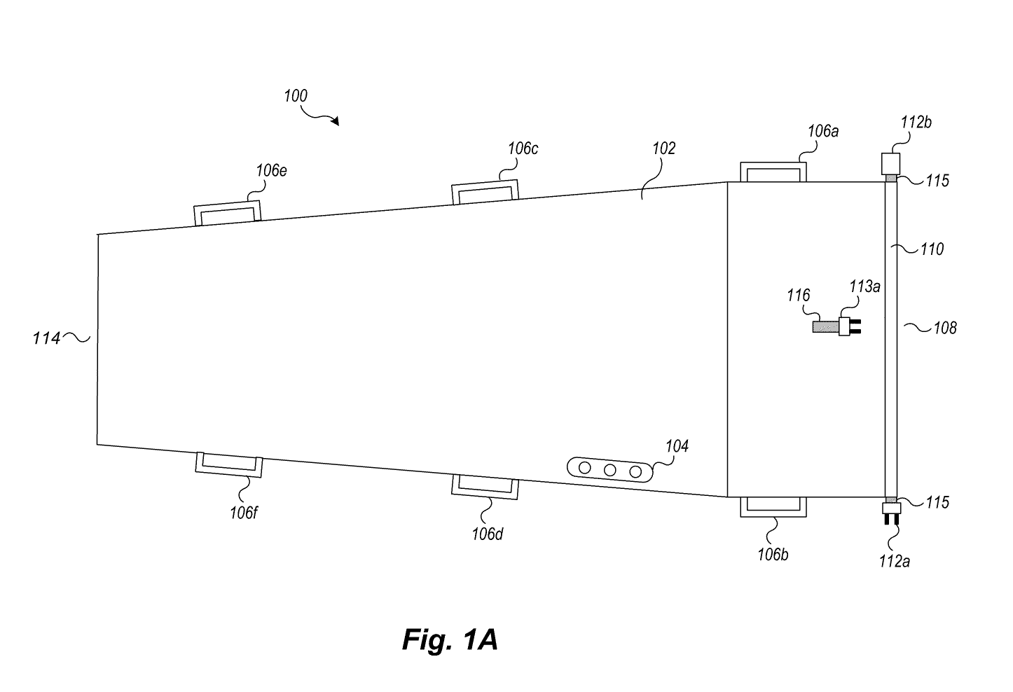

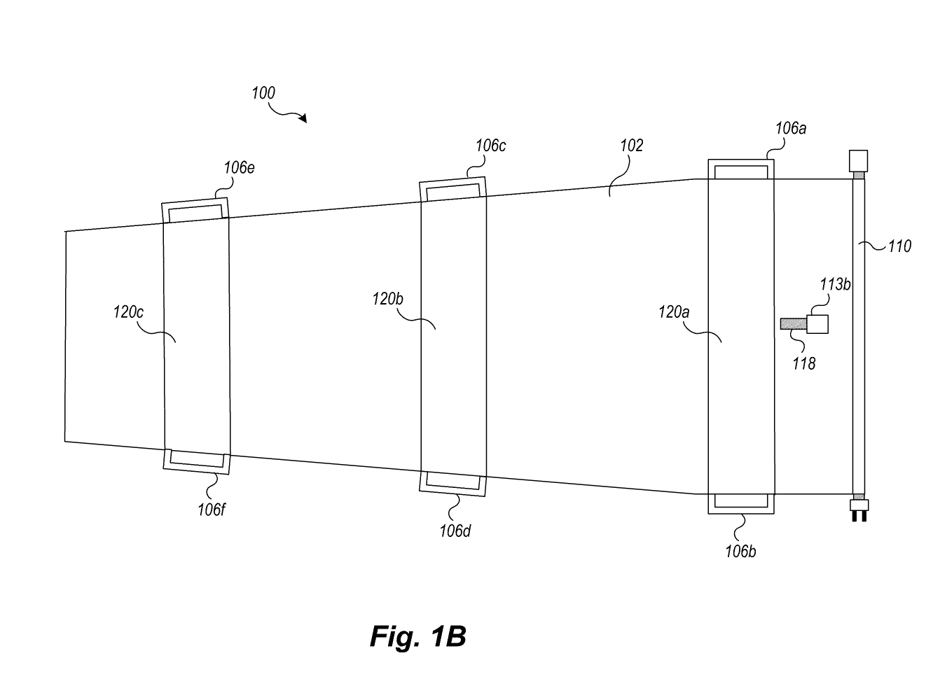

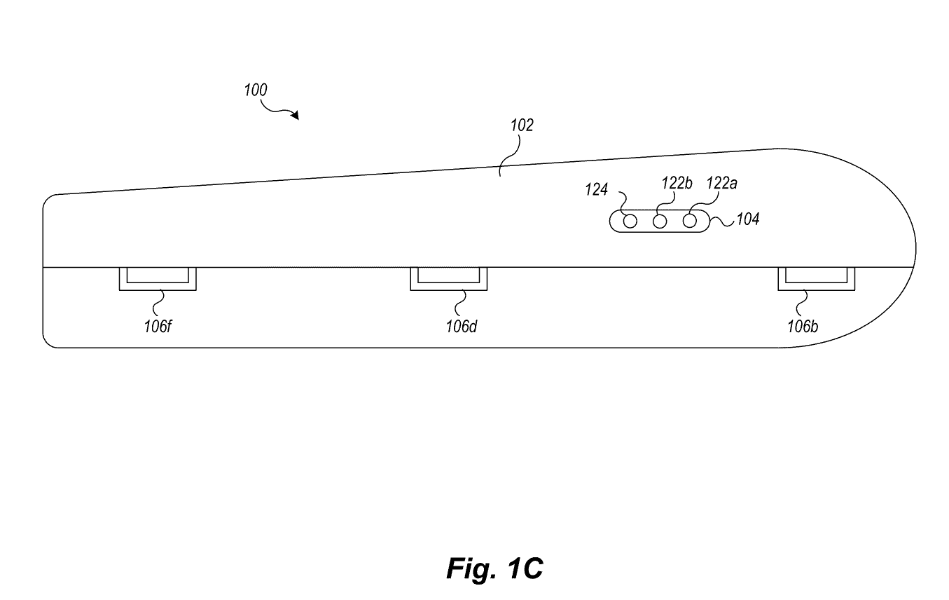

FIGS. 1A-1C are various views of a first embodiment of a hyperbaric therapy device. In particular, FIG. 1A is a top view of an HTD 100. In the view of FIG. 1A, the HTD 100 is deflated and laid out in a substantially flat position. The HTD 100 includes a chamber 102 having ends 108 and 114, a port group 104, multiple handles 106a-106f, and a roll-down closure 110.

The chamber 102 resembles a tube that includes an opening at end 108 and that tapers towards end 114. End 114 is closed. The chamber 102 is large enough to contain an above-average-sized (e.g., two meters in length) adult human patient. Thus, the illustrated chamber is approximately 2.25 meters in length. The chamber 102 may be smaller or larger than shown here. For example, in one embodiment the chamber 102 of the HTD is adapted for use with juvenile patients, and is accordingly sized (e.g., about 1.5 meters in length). The chamber is constructed substantially from a high strength, low weight (e.g., a mass of less than 150 grams per square meter), substantially air impermeable material, such as a flexible composite laminate material.

The opening at end 108 is large enough to permit passageway by the patient. In a typical application, the patient enters via the opening at end 108, and lies inside of the chamber 102, with their head at end 108 and feet at end 114. The chamber 102 is then sealed using closure 110. Next, the bag is inflated via the port group 104 to an internal pressure that is at least 0.5 psi (“pounds per square inch”) higher than the ambient air pressure. Any internal pressure that is higher than ambient air pressure may provide therapeutic benefits. Generally, the higher the internal air pressure, the more effective the treatment. For example, at 20000 feet, example internal air pressures of 0.5, 2, and 6 psi above the ambient air pressure respectively yield simulated descents of about 2000 feet (e.g., to 18000 feet), over 5000 feet (e.g., to 15000 feet), and over 15000 feet (e.g., to 5000 feet). Thus, an internal air pressure of at least 0.5 psi is preferable, with higher pressures yielding increasingly effective results. As the material of the chamber 102 is substantially air impermeable, an internal air pressure that is higher than ambient air pressure can be maintained without continuous pumping.

In the illustrated embodiment, the roll-down closure 110 includes fasteners 112 and 113. Fasteners 112 and 113 may be oriented to reinforce the operation of one another. For example, as shown, fasteners 112 and 113 are oriented substantially perpendicularly to one another. In the embodiment of FIGS. 1A-1C, fasteners 112-113 are side release buckle fasteners. Fastener 112 includes a male portion 112a that can be removably coupled to a female portion 112b. Each fastener portion 112a-112b includes a ladder lock that can be threaded and adjustably secured to a webbing strap 115. The strap 115 is coupled to the material of the chamber 102 (e.g., sewn or laminated onto the chamber), and runs along the top and/or bottom portion of the chamber 102 at end 108, from one side to the opposite side of the chamber 102. Fastener 113 includes a male portion 113a which can be removably coupled to strap 116 and to a female portion 113b that is shown in FIG. 1B. The strap 116 is coupled to the material of the chamber 102. Although the illustrated fasteners 112-113 are side release buckles, other types of fasteners are contemplated, including ladder locks, cord locks, snap hooks, cam buckles, and the like.

To seal the chamber 102, an operator manipulates the closure 110 in the manner of a dry-bag closure. In particular, the operator first presses together the top and bottom portions of the chamber along the opening at end 108. Then, the operator repeatedly rolls the material of the chamber 102 about the strap 115. After at least two rotations about the strap 115, the operator couples portions 112a and 112b of the fastener 112 and tightens the strap 115, by pulling excess webbing of the strap through the ladder lock of portion 112a and/or 112b. After securing fastener 112, the operator secures fastener 116, thereby providing reinforcement to fastener 112 by inhibiting the tendency of the rolled material to unroll when subject to an increase in internal pressure of the chamber 102. Together, fasteners 112 and 116 hold the closure 110 in place during inflation. Without an additional fastener (116), the closure 110 may unroll during or after inflation, resulting in loss of pressure during hyperbaric treatment.

Other types of closures are contemplated. In one embodiment, the closure 110 includes a zipper style seal (e.g., similar to those found in Ziploc® brand plastic storage bags) that is arranged about the inner circumference of the opening 108 of the chamber 102. Top and bottom portions of the zipper style seal can be joined, so as to provide a substantially air-tight seal for the chamber 102. Operation of the zipper style seal can then be further enhanced by rolling material of the chamber 102 and then securing the rolled material by way of one or more fasteners, as described above.

FIG. 1B is a bottom view of the HTD 100. In the view of FIG. 1B, the HTD 100 is deflated and laid out in a substantially flat position. The view of FIG. 1B shows the female portion 113b of the fastener 113 as well as a strap 118 that is coupled to the female portion 113b and to the material of the chamber 102. When the female portion 113b is coupled to the male portion 113a (FIG. 1A) and the straps 116 and 118 are securely tightened via the respective ladder locks of portions 113a and 113b, the fastener 113 reinforces the operation of fastener 112, as described with reference to FIG. 1A, above.

FIG. 1B also shows that the HTD 100 includes reinforcing straps 120a-120c. The straps 120a-120c couple handles 106a-106f to one another. In particular, strap 120a couples handle 106a to handle 106b; strap 120b couples handle 106c to handle 106d; and strap 120c couples handle 106e to handle 106f. The handles 106 and straps 120 are typically made from the same or similar material to that of the chamber 102. The handles 106 and straps 120 together are strong enough such that the HTD 100 can be carried when it contains an adult human patient. Thus, the handles 106 can be used for transport of the HTD 100, such as by being hand carried by one or more operators. In other situations, the handles 106 can be used to secure the HTD 100 to a litter and/or to surrounding terrain (e.g., rock, snow, trees, earth) to keep it from moving. Other types of straps or loops may be use in addition to, or instead of, the handles 106. For example, small loops of fabric that are coupled to the chamber 102 may be included for additional tie-down points on the HTD 100.

FIG. 1C is a side view of the HTD 100. In the view of FIG. 1C, the HTD 100 is inflated and laid out in a substantially flat position. The view of FIG. 1B shows one side of chamber 102, the port group 104, and handles 106b, 106d, and 106f. The port group 104 of the illustrated embodiment includes inflation valves 122a and 122b, and pressure relief valve 124. The port group 104 is coupled to the chamber 102, such as by stitching and/or lamination. The valves 122 and 124 respectively provide for ingress and egress of air into and out of the chamber 102. The pressure relief valve 124 is operable, when the internal air pressure of the chamber 102 exceeds a predetermined maximum air pressure, release air from the chamber 102.

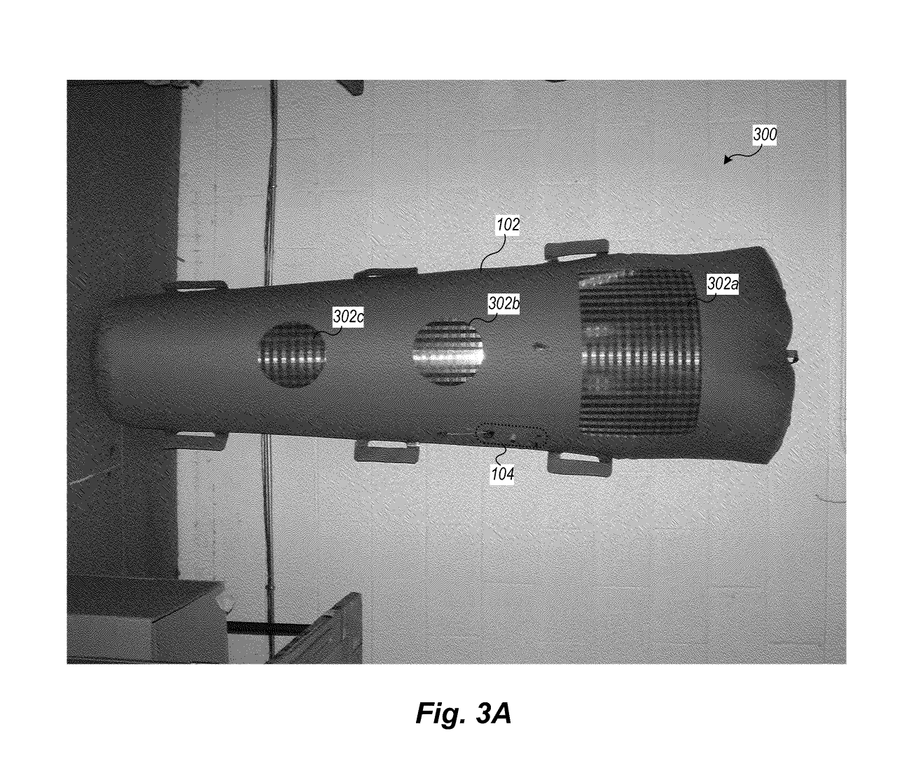

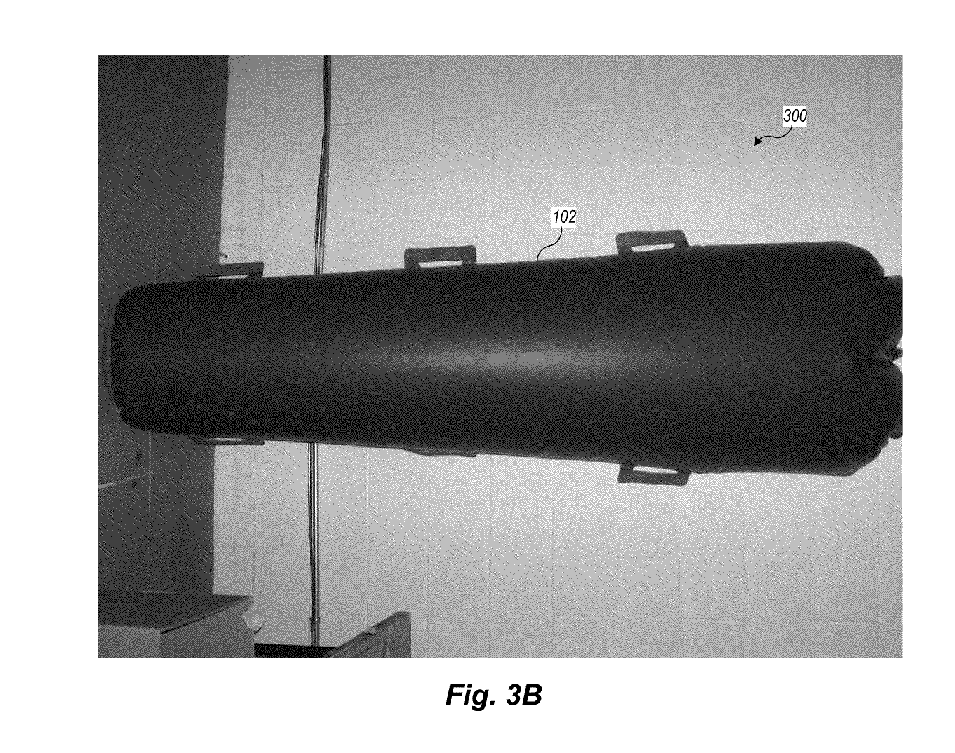

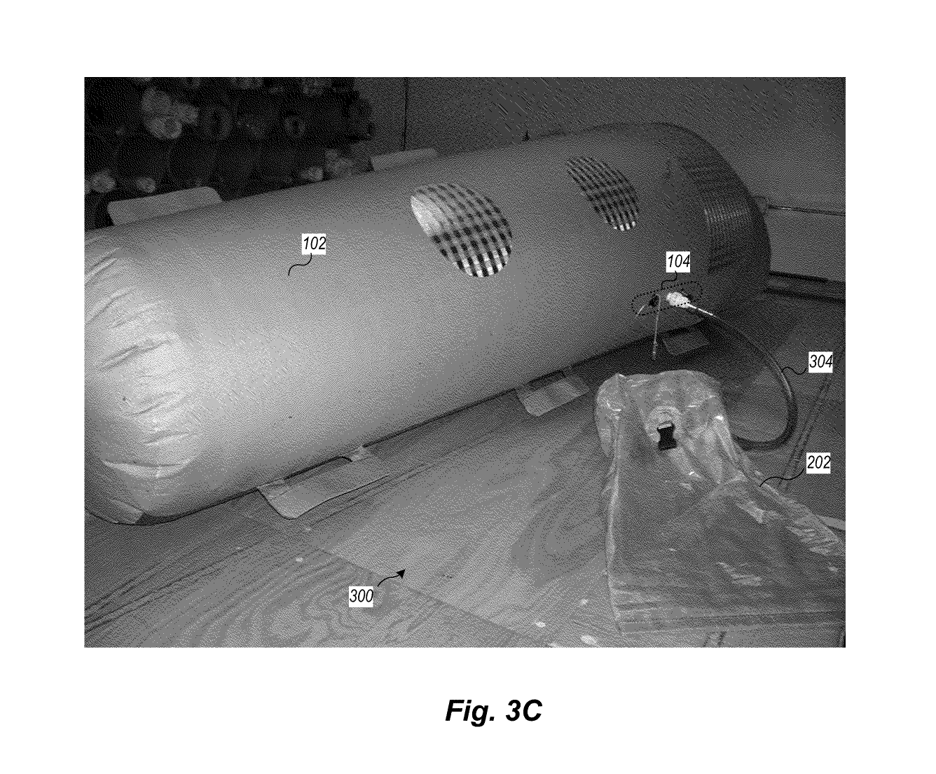

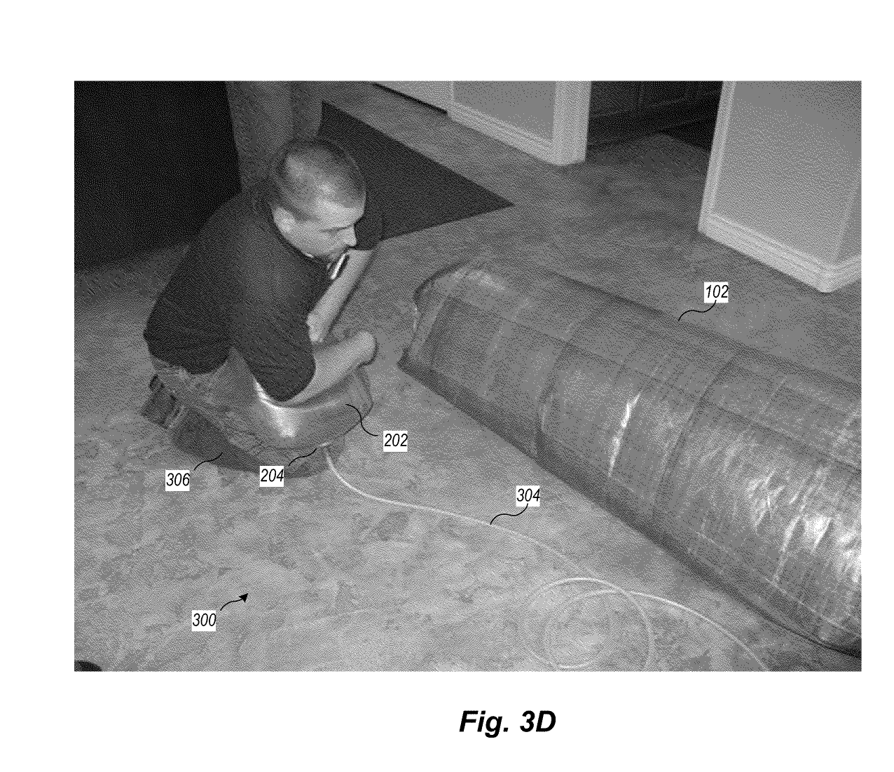

The inflation valves 122a and 122b are of distinct types and are adapted to receive couplings from different types of pump systems. For example, valve 122a may be adapted to receive a coupling from a high volume, low pressure pump, and valve 122b may be adapted to receive a coupling from a low volume, high pressure pump. The multiple inflation valves of port group 104 provide many benefits, including supporting a dual pump inflation technique, in which an operator uses a high volume, low pressure pump to initially introduce a large volume of air into the chamber 102. The operator then switches to a low volume, high pressure pump to reach and maintain an operational internal air pressure. The dual pump inflation technique and other information regarding HTD pump systems and techniques are described further with reference to FIGS. 3A-3D, below. As another advantage, the multiple inflation valves of port group 104 allow for the use of various different types of pumping systems without resort to specialized couplings or adapters, which are easily misplaced and difficult to install in the harsh conditions typically experienced at high altitude. Although the valves 122 and 124 are shown placed near one another in port group 104, in other embodiments, various valves may not be located proximate to one another or otherwise grouped in any particular manner.

The hyperbaric therapy device will now be further described with reference to various specific example embodiments. In the following description, numerous specific details are set forth, such as material manufacturers, dimensions, weights, and the like, in order to provide a thorough understanding of the described invention. It is understood that the embodiments described also can be practiced without some of the specific details described herein, or with other specific details, such as changes with respect to the pump systems used, number and arrangement of straps or handles, and the like.

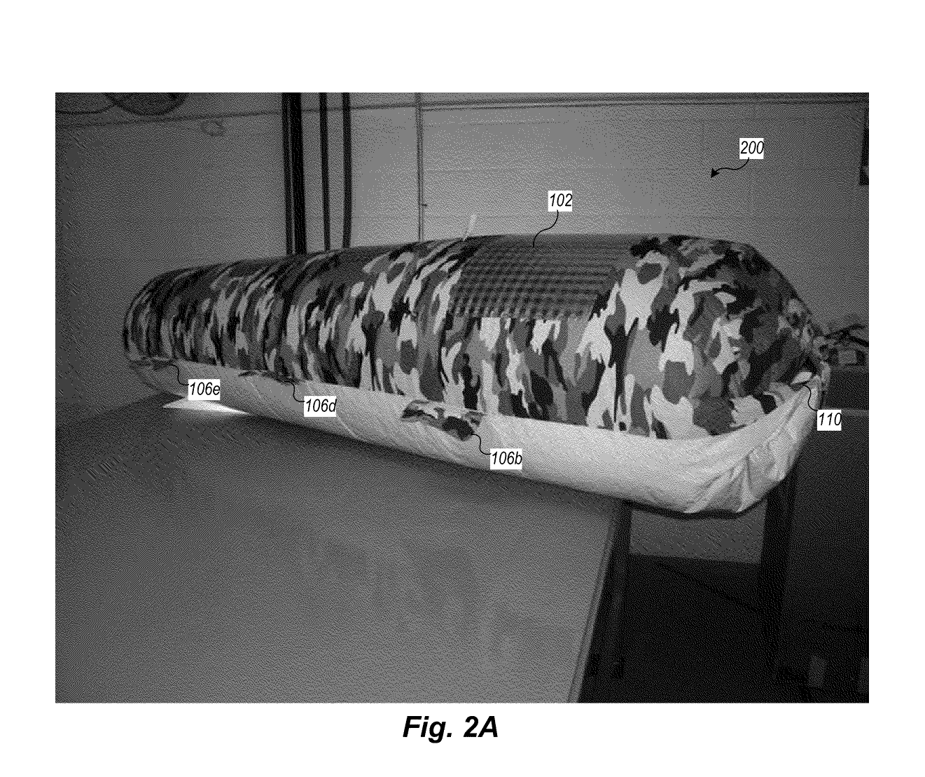

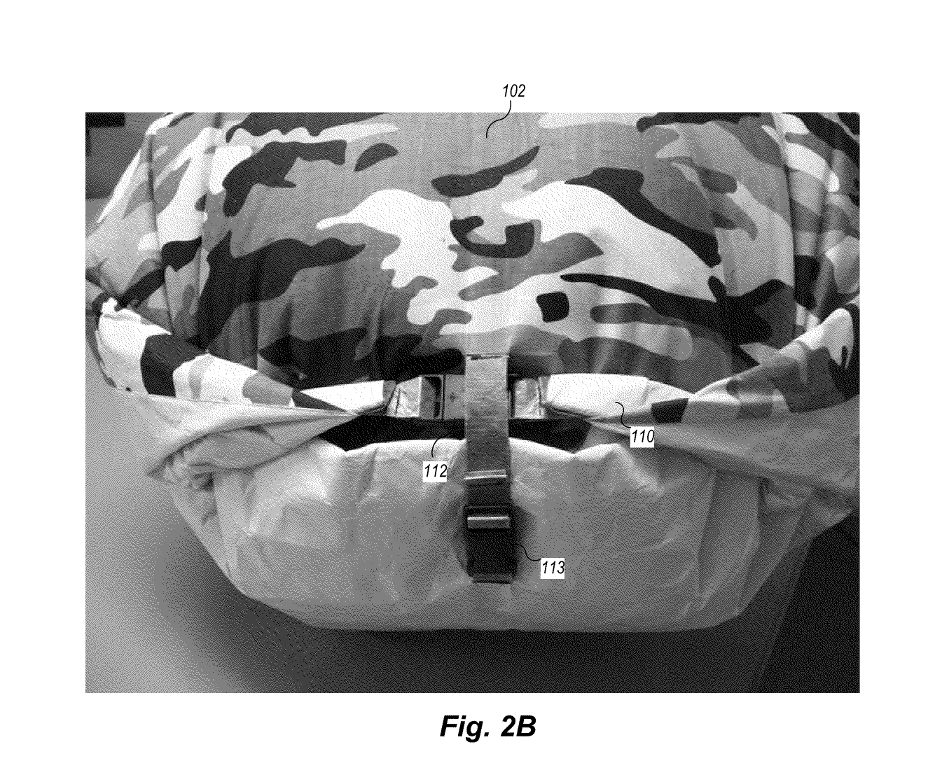

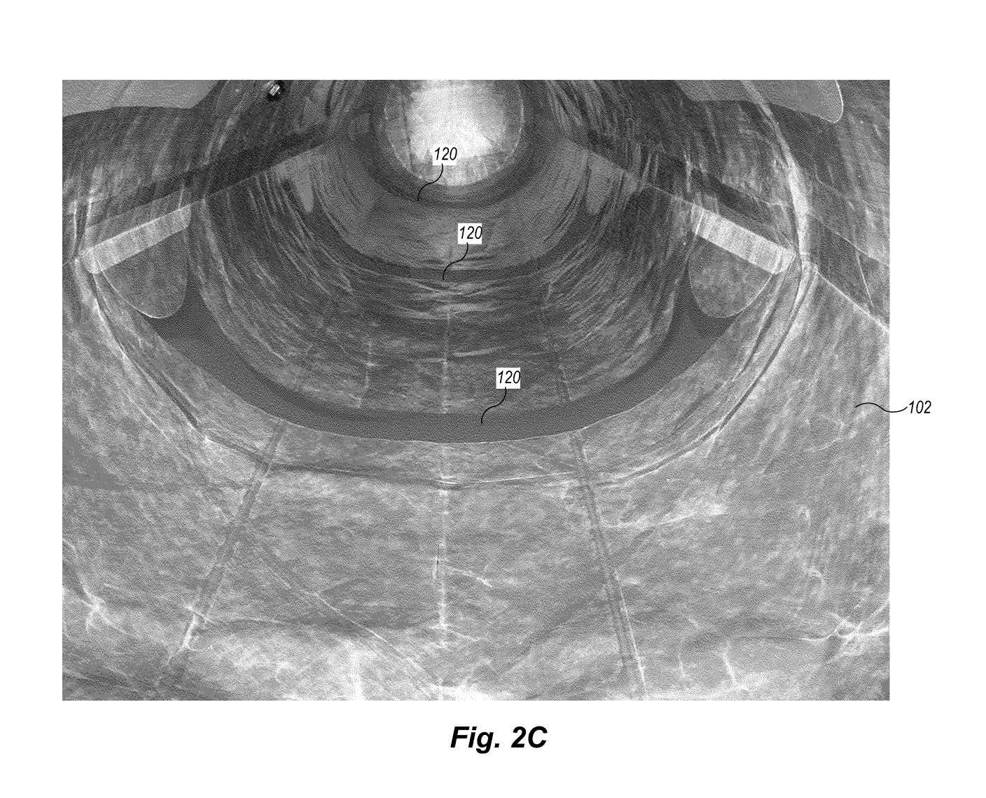

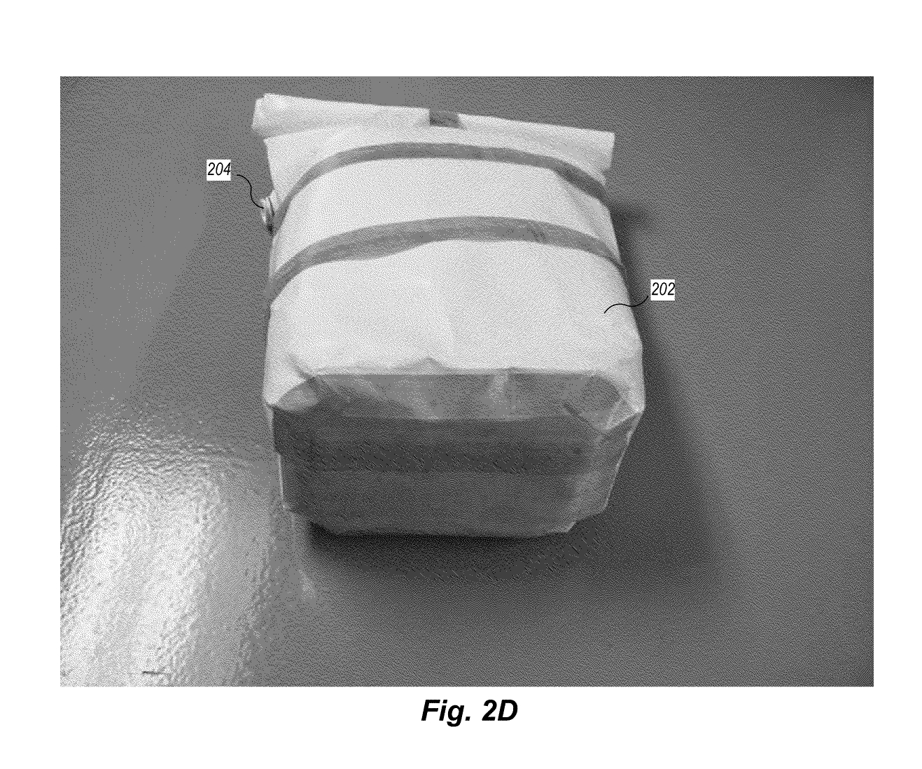

FIGS. 2A-2D are various views of example embodiments of a hyperbaric therapy device. FIGS. 2A-2D provide details about materials that may be utilized in constructing an example hyperbaric therapy device, as well as various features thereof, including full-strength carry handles.

FIG. 2A is a perspective view of an HTD 200. As shown in FIG. 2A, the HTD 200 includes a chamber 102, a roll-down closure 110, and handles 106. The chamber 102, handles 106, and other components of the HTD 200 are constructed from a flexible composite laminate material, such as a fabric produced by Cubic Tech Corp., and marketed under the trade name Cuben Fiber. Cuben Fiber fabric is constructed by laminating plasma treated ultra high molecular weight polyethylene fibers and monofilament polyester film. In other embodiments, other types of fibers (e.g., carbon fibers) and/or other types of films (e.g., polyvinyl fluoride film) may be utilized. The flexible composite laminate material is a high shear strength, low weight, low volume material that is extremely durable and substantially air impermeable. Additionally, holes or tears in the flexible composite laminate material do not propagate into the material even when under stress. The flexible composite laminate material may be woven or non-woven, depending on desired properties such as strength and/or abrasion resistance. By constructing the chamber 102 and other components of the HTD 200 from flexible composite laminate material, weight and volume are substantially reduced compared to conventional hyperbaric chambers.

FIG. 2B is an end view of the HTD 200 providing a detailed view of the closure 110. The closure 110 is shown in sealed position, with material of the chamber 102 rolled and fastened, first with fastener 112 and second with fastener 113. Fasteners 112 and 113 are positioned substantially perpendicular to one another. Additional fasteners and/or fasteners of different types may be used. For example, in one embodiment, fastener 113 may include a hook-and-loop (e.g., a Velcro® brand fastener) used to secure a strap across and/or over fastener 112.

FIG. 2C is an inside view of the chamber 102 of the HTD 200. Visible in FIG. 2C are the straps 120. In the HTD 200, the straps 120 are integrated (e.g., laminated) to the inside wall of the chamber 102. In other embodiments, such as the one described with reference to FIG. 1, above, the straps are located on the outside wall of the chamber 102. The straps 120 are also made from flexible composite laminate material.

Each of the handles 106 (not shown in this view) is integrated with one of straps 120 that runs across the bottom of the chamber 102 to one of handles 106 on the opposite side for strength. Conventional portable hyperbaric chambers require a separate stretcher and strap system to transport a patient undergoing treatment. Typically, conventional hyperbaric chambers are loaded onto the stretcher, and then secured with straps tightened down over the top of the hyperbaric chamber. The litter retaining straps cause the pressure inside of the conventional hyperbaric chamber to increase and decrease at an unsafe rate if proper pressure is not meticulously maintained by the operator. In contrast, the handles 106 and straps 120 of the HTD 100 allow for immediate transport of a patient without a litter or retaining straps, representing a substantial reduction in patient transport times and required equipment.

FIG. 2D is an end view of a storage bag (e.g., stuff sack) 202 for the HTD 200. In this configuration, the HTD 200 is compressed (e.g., rolled or stuffed to a small size) and placed inside of the storage bag 202. The storage bag 202 is also made from flexible composite laminate material. In addition, the storage bag 202 includes a valve 204 that can be coupled to an inflation valve of the chamber 102 of the HTD 200, such that the storage bag 202 can be used as a high volume, low pressure pump for inflation of the chamber 102. Inflation using a storage bag is described further with reference to FIGS. 3C-3D, below.

FIGS. 3A-3D are additional views of example embodiments of a hyperbaric therapy device. FIGS. 3A-3D provide details about inflation techniques and devices that may be utilized in conjunction with an example hyperbaric therapy device.

FIG. 3A is a top view of an HTD 300. As shown in FIG. 3A, the HTD 300 includes a chamber 102, a port group 104, and three viewports 302a-302c. The viewports 302 are made from substantially transparent flexible composite laminate material. In addition, the viewports 302 are positioned such that an operator can obtain a view of a portion of a patient who is inside of the chamber 102. In particular, the viewports 302a-302c are respectively positioned to provide views of the head, trunk, and legs of a patient located within the chamber 102.

The port group 104 includes two inflation valves and a pressure relief valve. In the illustrated embodiment, the pressure relief valve is operable, when the internal air pressure of the chamber 102 exceeds a predetermined maximum air pressure, release air from the chamber 102. In the illustrated embodiment, the pressure relief valve is a Halkey Roberts® model 780 RPP pressure relief valve. This valve is an industry standard for hyperbaric chambers with a longstanding history of performance at altitude. The 780 RPP pressure relief valve is available with standard relief pressures of between 0.1 and 15.0 psi, or can be manufactured with a custom relief pressure. In the illustrated example embodiment, a 780 RPP pressure relief valve having a relief pressure of 2.0 psi has been selected. In other embodiments, other types and/or models of pressure relief valves are utilized. Some embodiments employ a pressure relief valve having a field-adjustable relief pressure, such that the operator can select from a range of possible relief pressures, depending on factors such as altitude, patient condition, treatment schedule, and the like.

Various types of inflation valves may be used as part of port group 104. The valves are adapted to receive a coupling from various types of pumps. Existing hyperbaric chambers utilize a bellows-style foot pump with a single fitting to inflate the chamber. In contrast, some embodiments of the HTD are compatible with a variety of widely available pump systems. This flexibility and redundancy in the inflation systems can yield significant weight reduction and provide added safety in case of pump failure or loss.

Any type of pump, and in some embodiments multiple pumps, may be used to reach and maintain an internal pressure of the chamber 102 of at least 0.5 psi above ambient pressure, which can simulate a descent of about 2000 feet at 20000 feet of elevation. Preferably, a pump system is adapted to reach and maintain a pressure of about 2 psi, which simulates a descent of over 5000 feet at 20000 feet of elevation.

In one embodiment, a primary high pressure pump system used as part of the HTD is a Bag Valve Mask (“BVM”) pump that is commonly used for patient resuscitation. Many medical providers, high altitude climbers, and/or military personnel carry this pump system in medical kits, making it easy to procure and convenient to deploy in rescue scenarios or resupply situations. To support the BVM pump, the port group 104 may include a one-way valve that mates to a standard 15/22 mm Bag Valve Mask port, such as the Halkey Roberts C737SUX check valve with a tapered adapter. The opening pressure for the check valve is approximately 0.25 psi and compatible with standard Bag Valve Masks and Ventilators.

A secondary high pressure pump option may be any inflation device with a Schrader-type fitting. Bicycle pumps, emergency tire pumps, or air compressors can all typically interface with the Schrader-type fitting, and thus can be used to reach and/or maintain air pressure inside the chamber 102. The secondary pumps represent an evolution in hyperbaric treatment as they provide the ability to give care with an automated device. All other systems require physical exertion (e.g., via a foot pump) from a rescuer—potentially causing and/or exacerbating AMS symptoms in the rescuer. An automatic inflation system allows for more detailed patient management during treatment.

Table 1, following provides additional details regarding various types of pump systems and corresponding inflation valves that may be used in various embodiments.

TABLE 1

| High | Associated | |
|---|---|---|
| Pressure | Inflation | |
| Pump | Valve | Description |
| Simpli- | 15/22 BVM | The SAVe is a lightweight pump system that is |
| fied | Port | widely used by the U.S. Special Operations |
| Auto- | | Command community. The SAVe vent is |
| mated | | capable of inflating 6 L/min to a maximum |
| Ventilator | | pressure of 38 cm/H20 (.54 psi) for 5.5 hours. |
| (“SAVe”) | | Although the SAVe will not inflate to a higher |
| | | effective pressure (e.g., 2 psi), it will provide an |
| | | initial, automatic method of inflation to enable |
| | | the care provider to focus on patient vital signs |
| | | during treatment. Once the SAVe ventilator |
| | | inflates the HTD to the maximum pressure |
| | | obtainable with the SAVe, the care provider |
| | | will typically change inflation devices in order |
| | | to in crease the internal pressure in the bag to |
| | | simulate further descent. |
| Ambu | 15/22 BVM | The Ambu SPUR II Adult Bag Valve Mask is a |
| SPUR II | Port | commonly used and widely available |
| Adult | | resuscitation device. The SPUR II is currently |
| BVM | | used by the U.S. Military, NATO forces, and |
| without | | EMS communities worldwide. The device has |
| Relief | | the capability of .8 L tidal volume for one- |
| Valve | | handed operation and 1.1 L of tidal volume for |
| | | two-handed operation. With the addition of |
| | | simple ventilator tubing, a care provider can |
| | | gain standoff from the chamber and inflate the |
| | | device from a rest or low-profile position. |
| Any | Schrader | The Schrader valve is the worldwide standard |
| Schrader | Valve | for automobile and bicycle tire inflation. This |
| Valve | | valve gives enables the chamber to be inflated |
| compat- | | via various manual or powered devices. |
| ible | | Anywhere on the planet, operators will typically |
| pump | | have access to a 12 volt inflation device or a |
| | | manual bicycle pump. One example of a manual |
| | | pump is the Blackburn Carbon Fiber Frame |
| | | Pump. The Blackburn Carbon Fiber Frame |
| | | Pump delivers high volume and pressure, with a |
| | | low unit weight and pack size. |
| Nemoid | Nemo | Nemo Equipment's Nemoid pump is compact, |
| Pump | Inflation | light, and pushes a substantial amount of air |
| and | Valve | into the chamber in a short amount of time. |
| Halkey | | The Nemo Equipment Nemoid pump can be |
| Roberts | | mated with a Halkey Roberts 720ROA valve. |
| Valve | | |

As noted, example hyperbaric therapy devices are very light as compared to existing hyperbaric chambers. One example embodiment constructed from flexible composite laminate (e.g., Cuben Fiber fabric) and including several of the above valves has a mass of about 1.2 kg. Table 2, below, provides a listing of system components and their associated masses.

TABLE 2

| Component | Mass | |
|---|---|---|
| Cubic Tech Chamber | 1088 | grams |
| Halkey Roberts 780RPP Relief Valve | 25 | grams |
| Halkey Roberts C737SUX Check Valve | 4.5 | grams |
| Nemo Inflation Valve | 45.4 | grams |
| Schrader Valve | 50 | grams |
| System Mass | 1213 | grams (2.671bs) |

As noted above, the weight and bulk of the HTD are related to the likelihood that an operator will actually carry the HTD into the types of environments where it will provide maximum benefit. Thus, an effective weight or mass of the HTD can be gauged based on what can be reasonably carried in the pack of a high altitude operator. In one application, an embodiment of the HTD has a compressed (e.g., packed) volume of not more than 10 liters and a mass of not more than 5 kilograms. In another application, an embodiment of the HTD has a compressed volume of not more than 5 liters and a mass of not more than 3 kilograms. In a further application, an embodiment of the HTD has a compressed volume of not more than 2 liters and a mass of not more than 2 kilograms.

FIG. 3B is a bottom view of the HTD 300. In this view, the bottom of chamber 102 is visible. In some embodiments, the bottom portion of the chamber 102 is manufactured from a stronger, more abrasion resistant, and/or higher rip-stop material than the top portion of the chamber 102.

FIG. 3C is an end/side view of the HTD 300. In this view, the port group 104 of the chamber 102 is visible. One of the inflation valves of the port group 104 is connected via a hose 304 to the storage bag 202. The storage bag 202 is being readied for use in inflating the chamber 102, as will be described next with reference to FIG. 3D.

FIG. 3D shows the HTD 300 during inflation with the storage bag 202. As noted above, the storage bag 202 for the HTD can be used in some embodiments as one of the pump systems for filling the chamber 102. As shown here, an operator 306 has connected the storage bag 202 to the chamber 102 via a hose 304. The hose is coupled via the valve 204 to the storage bag 202 and via a valve on the port group (not shown) to the chamber 102. The operator 306 operates the storage bag by inflating the bag and deflating it with his arm or other body portion. The storage bag 202 thus doubles as a high volume, low pressure pump that can be used to perform a rapid, initial fill of the chamber 102. Once the maximum output of the storage bag 202 pump is reached, the operator 306 can then switch to another pump, such as one described above with reference to Table 1, to reach and maintain the desired air pressure inside of the chamber 102. The rapid initial inflation of the chamber 102 provides a significant improvement in treatment times over conventional systems. By inflating the chamber 102 faster, with a lighter pump, treatment can be initiated more quickly and with less effort from the rescuer.

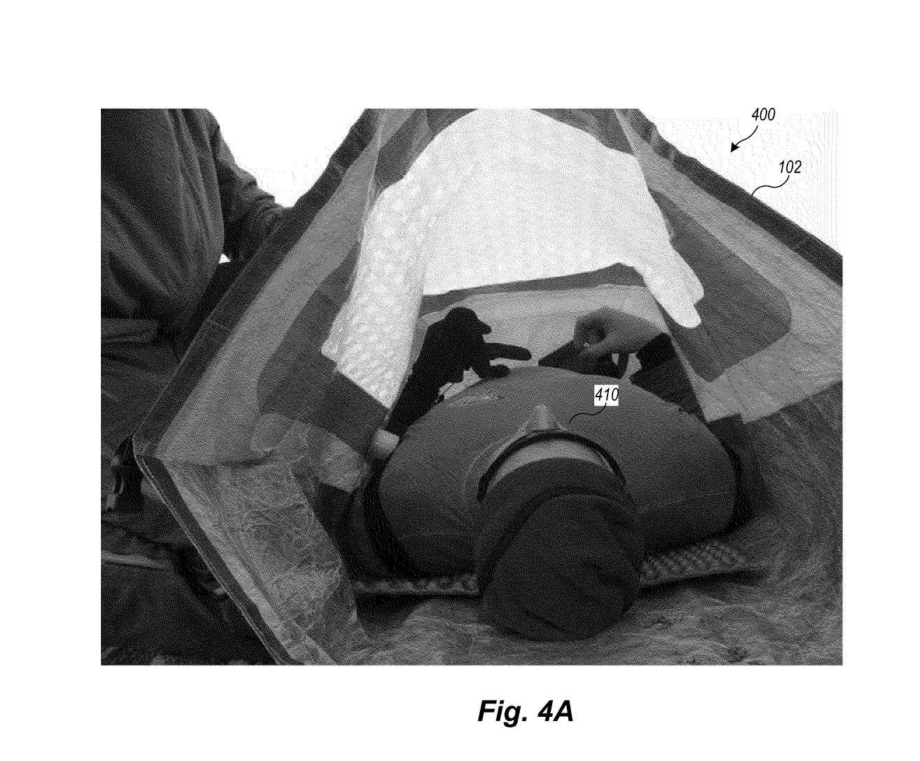

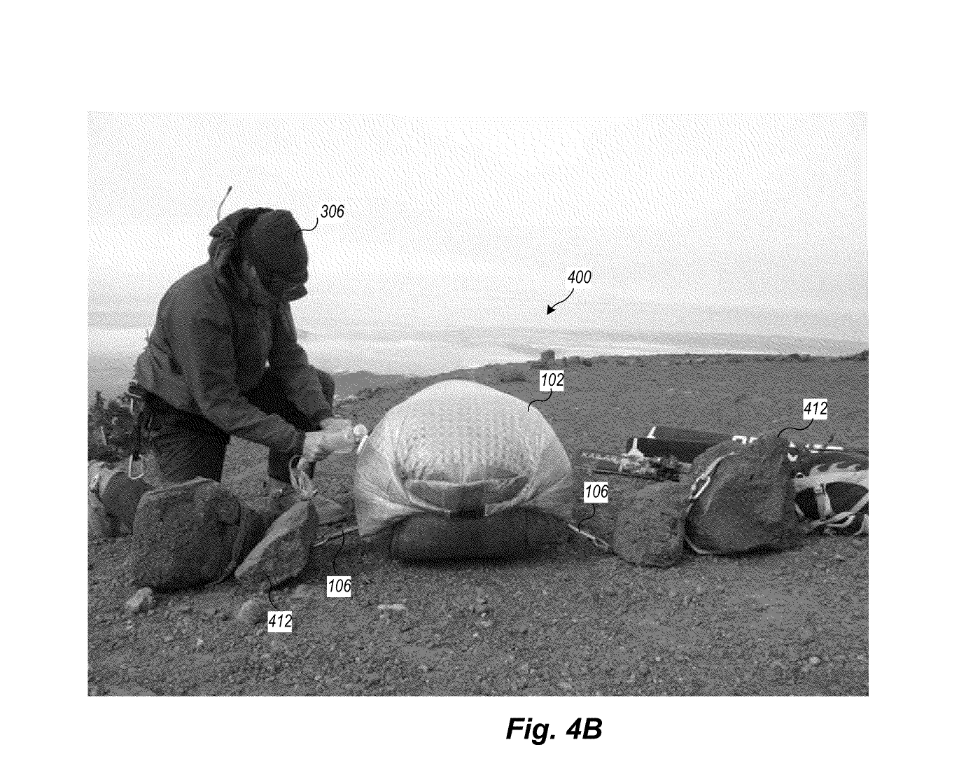

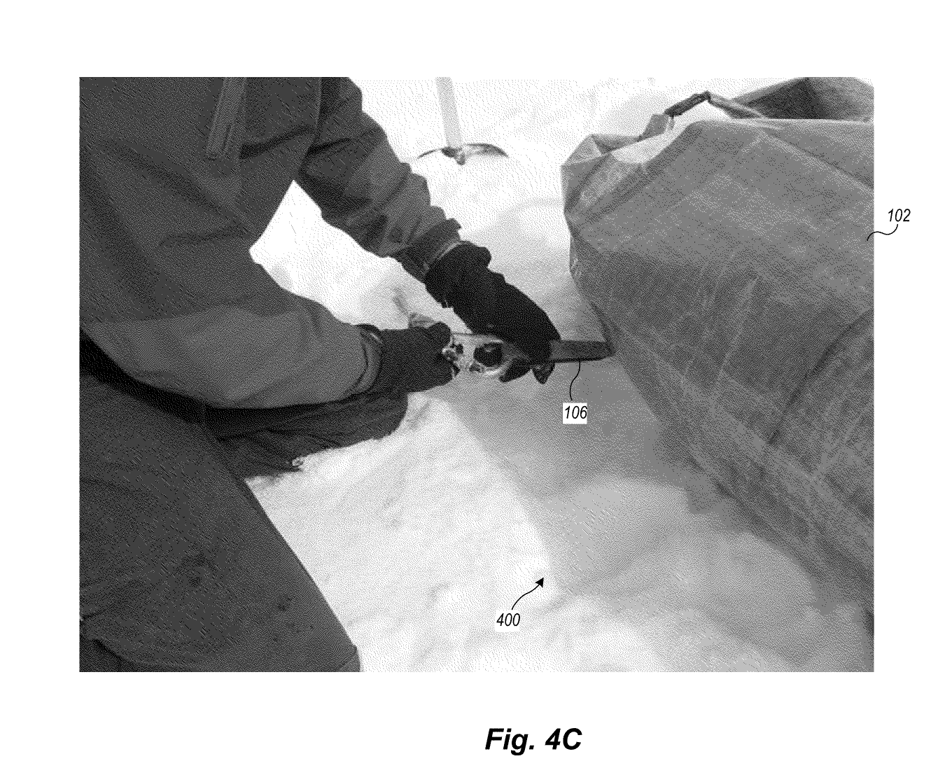

FIGS. 4A-4C are further views of example embodiments of a hyperbaric therapy device. FIGS. 4A-4C provide details about various additional features and/or uses of example hyperbaric therapy devices.

FIG. 4A shows an inside view of the HTD 400 taken from the head end of the chamber 102. A patient 410 is shown lying inside of the chamber 102. The chamber 102 is sufficiently large for an above average-sized adult male patient along with other equipment, such as warm clothing, a sleeping bag, an insulating sleeping pad, or the like.

FIG. 4B shows an end view of the HTD 400. In this arrangement, the chamber 102 is secured via the straps 106 to anchors 412, in this case rocks. An operator 306 is shown filling the chamber 102 with a manual pump system.

FIG. 4C shows a detail view of anchoring the HTD 400 via one of the straps 106. In this figure, the chamber 102 is secured via the strap 106 to a snow anchor, such as a picket, dead man, embedded ice axe, or the like. In other environments, other types of anchors may be used, including ice screws, active or passive rock climbing anchors, or the like. The ability to secure the HTD 400 to its surroundings is useful when operating in non-horizontal, low friction (e.g., snow/ice) environments, such as are often found in high altitude settings.

Although the hyperbaric therapy device and related techniques have been described above primarily with reference to treatment of altitude related illnesses and/or injuries, it can be used in other contexts and/or for other purposes as well. For example, the HTD is well suited for use as an emergency or bivouac shelter. As discussed above, the chamber of the HTD is constructed from substantially air impermeable material, and is thus also substantially water and wind-proof. Furthermore, the HTD can be secured via straps and/or handles to its surroundings.

As another example, the HTD can be used to rapidly move a patient from a dangerous location. The chamber and handles of the HTD are strong enough to place the patient in or on the chamber of the HTD, and haul or slide the patient out of danger. Depending on the ground conditions, the HTD may be dragged longer (e.g., lower friction surfaces such as snow or sand) or shorter (e.g., higher friction surfaces such as gravel or talus) distances before the material of the chamber of the HTD becomes so degraded as to diminish or destroy its function for treating altitude related illnesses and/or injuries. In a related manner, the strength of the chamber and its associated handles allows the HTD to be utilized as a body bag for carrying a deceased person.

Also, as discussed above, the chamber of the HTD is sufficiently large to include additional insulation, such as pads, clothing, and or sleeping bags for a patient. As such, the HTD may be used as a wrap for treating hypothermic patients.

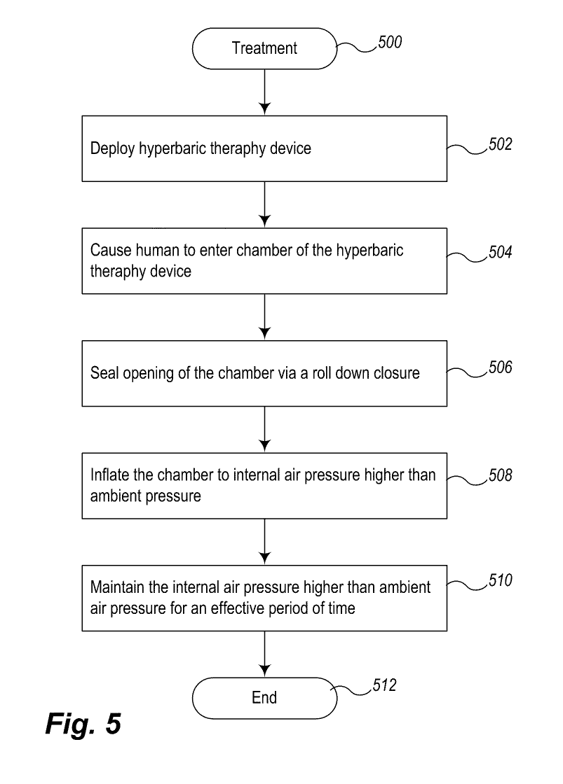

FIG. 5 is a flow diagram of a process 500 for treating altitude related illnesses and/or injuries. The illustrated process 500 may be performed by an operator of the hyperbaric therapy device described herein.

The process 500 begins at 502, where an operator deploys the hyperbaric therapy device. Deploying the hyperbaric therapy device may include removing the chamber from its storage bag, and unrolling or otherwise uncompressing the chamber. Deploying the hyperbaric therapy device may further include securing the chamber via handles and/or other fixtures (e.g., straps, loops) coupled to the hyperbaric therapy device.

At 504, the operator causes a human patient to enter the chamber of the hyperbaric therapy device via an opening in the chamber. If the patient is able, they may enter the chamber under their own power. Otherwise the operator may insert the patient into the chamber, such as by pulling the chamber up over the patient, starting at the feet of the patient and proceeding upwards to the head of the patient.

At 506, the operator seals the opening in the chamber using a roll-down closure. Sealing the opening may include pressing a top and bottom half of the opening together, and then rolling the material of the opening multiple times, such that a seal between the top and bottom halves is formed. Sealing the opening may further include securing the rolled material by way of one or more fasteners, such as buckles, hook and ladder straps, or the like.

At 508, the operator inflates the chamber to an internal pressure higher than ambient air pressure. As noted above, an internal pressure of between 0.5 and 2 psi above ambient pressure is preferred. Inflating the chamber includes utilizing one or more pump systems to input air into the chamber. In one embodiment, a dual pump procedure is utilized, in which the operator uses a first pump to introduce an initial volume of air into the chamber and then uses a second, higher pressure pump, to reach and maintain the desired internal pressure. In some embodiments, the storage bag of the hyperbaric therapy device can be utilized as a pump for at least partially inflating the chamber, such as the first pump in a dual pump procedure.

At 510, the operator maintains the internal air pressure higher than ambient air pressure for an effective period of time. The effective period may depend at least in part on the severity of the altitude related illness. In particular, the patient may stay inside of the chamber for as little as an hour to treat mild cases. For more severe cases, the patient may stay inside of the chamber for 12 or more hours, or until the patient can be evacuated to a lower elevation.

From the foregoing it will be appreciated that, although specific embodiments have been described herein for purposes of illustration, various modifications may be made without deviating from the spirit and scope of this disclosure. For example, other types of fasteners or materials may be used. Accordingly, the scope of the invention is not limited by the disclosure of the above-described embodiments. Instead, the scope of the invention should be determined entirely by reference to the claims that follow.

1. A hyperbaric therapy device, comprising:
a chamber large enough to contain an adult human patient, the chamber constructed substantially from a material that is substantially impermeable to air, such that the chamber can maintain an internal air pressure that is higher than ambient air pressure, wherein the chamber includes an opening large enough to permit passage of the adult human patient;
a roll-down closure comprising a first fastener, the closure operable to seal the opening by rolling material of the chamber, and securing the rolled material in position with the first fastener;
a first inflation valve coupled to the chamber and operable to, when connected to a pump system, inflate the chamber to the internal air pressure; and
a pressure relief valve coupled to the chamber and operable to, when the internal air pressure exceeds a predetermined maximum air pressure, release air from the chamber.

2. The hyperbaric therapy device of claim 1, further comprising at least one pair of fabric loops coupled to the chamber, wherein the fabric loops of the at least one pair are situated on substantially opposite sides of the chamber and are coupled to one another via a strap running across the bottom of the chamber.

3. The hyperbaric therapy device of claim 2 wherein the fabric loops are strong enough to bear the weight of the chamber when it contains an adult human patient.

4. The hyperbaric therapy device of claim 1, further comprising a second inflation valve of a type that is different from a type of the first inflation valve, the second inflation valve coupled to the chamber and operable to, when connected to a pump system, inflate the chamber to the internal air pressure.

5. The hyperbaric therapy device of claim 4, wherein the first inflation valve is adapted to receive a coupling to a low pressure pump, and wherein the second inflation valve is adapted to receive a coupling from a high pressure pump.

6. The hyperbaric therapy device of claim 1 wherein the roll-down closure includes a second fastener that is oriented substantially perpendicularly to the first fastener, the second fastener operable to reinforce operation of the first fastener.

7. A hyperbaric therapy device, comprising:
a chamber large enough to contain an adult human patient, the chamber constructed substantially from a material that is substantially impermeable to air, such that the chamber can maintain an internal air pressure that is higher than ambient air pressure;
a first inflation valve coupled to the chamber and operable to, when connected to a pump system, inflate the chamber to the internal air pressure;
a second inflation valve of a type that is different from a type of the first inflation valve, the second inflation valve coupled to the chamber and operable to, when connected to a pump system, inflate the chamber to the internal air pressure; and
a pressure relief valve coupled to the chamber and operable to, when the internal air pressure exceeds a predetermined maximum air pressure, release air from the chamber.

8. The hyperbaric therapy device of claim 7 wherein the first and second inflation valves are each one of a bag valve mask port, a Shrader valve, or a Nemo valve.

9. The hyperbaric therapy device of claim 7 wherein the first inflation valve is adapted to receive a coupling to a low pressure pump, and wherein the second inflation valve is adapted to receive a coupling from a high pressure pump.

10. The hyperbaric therapy device of claim 7, further comprising a bag valve mask pump coupled to the first inflation valve.

11. The hyperbaric therapy device of claim 10 wherein the bag valve mask pump is adapted to bring the chamber to an initial internal air pressure, and further comprising a high pressure pump adapted to bring the chamber from the initial internal air pressure to an air pressure of about 2 pounds per square inch above ambient air pressure.

12. The hyperbaric therapy device of claim 7, further comprising at least one pair of fabric loops coupled to the chamber, wherein the fabric loops of the at least one pair are situated on substantially opposite sides of the chamber, are coupled to one another via a strap running across the bottom of the chamber, and are strong enough to bear the weight of the chamber when it contains an adult human patient.

13. The hyperbaric therapy device of claim 7 wherein the flexible composite laminate material is non-woven flexible composite material and has a mass of less than 150 grams per square meter.

14. The hyperbaric therapy device of claim 13 wherein the non-woven flexible composite material is a laminate of ultra high molecular weight polyethylene fibers and a monofilament polyester film.

15. The hyperbaric therapy device of claim 7, having a mass of not more than 5 kilograms and having a compressed volume of not more than 10 liters.

16. A method for treating altitude-related disorders, the method comprising:
deploying the hyperbaric therapy device of claim 1;
causing a human patient to enter the chamber of the hyperbaric therapy device via the opening in the chamber;
sealing the opening in the chamber using the roll-down closure;
inflating the chamber to an internal air pressure higher than ambient pressure; and
maintaining the internal air pressure higher than ambient pressure for an effective period of time.

17. The method of claim 16 wherein inflating the chamber includes inflating the chamber to an internal air pressure of about 2 pounds per square inch above ambient air pressure.

18. The method of claim 16 wherein inflating the chamber includes using a first pump to introduce an initial volume of air into the chamber, and using a second pump to reach and maintain the internal air pressure.

19. The method of claim 16 wherein inflating the chamber includes coupling a bag valve mask pump to the first inflation valve.

20. The method of claim 16, further comprising using the hyperbaric therapy device as a rescue sled for the patient by transporting the chamber via fabric loops coupled to the chamber.

21. The method of claim 16, further comprising transporting the patient by affixing the chamber to a litter by way of fabric loops coupled to the chamber and without use of straps over the top of the chamber.

22. A hyperbaric therapy device, comprising:
a chamber large enough to contain an adult human patient, the chamber constructed substantially from a flexible composite laminate material that is substantially impermeable to air, such that the chamber can maintain an internal air pressure that is higher than ambient air pressure;
a first inflation valve coupled to the chamber and operable to, when connected to a pump system, inflate the chamber to the internal air pressure; and
a pressure relief valve coupled to the chamber and operable to, when the internal air pressure exceeds a predetermined maximum air pressure, release air from the chamber,
wherein the hyperbaric therapy device has a mass of not more than 5 kilograms and a compressed volume of not more than 10 liters.

23. The hyperbaric therapy device of claim 22, having a mass of not more than 2 kilograms and a compressed volume of not more than 2 liters.

24. The hyperbaric therapy device of claim 22 wherein the flexible composite laminate material is a laminate of ultra high molecular weight polyethylene fibers and a monofilament polyester film.

25. The hyperbaric therapy device of claim 22 further comprising at least one pair of fabric loops coupled to the chamber, wherein the fabric loops of the at least one pair are situated on substantially opposite sides of the chamber, are coupled to one another via a strap running across the bottom of the chamber, and are strong enough to bear the weight of the chamber when it contains an adult human patient.

26. The hyperbaric therapy device of claim 22, further comprising a second inflation valve of a type that is different from a type of the first inflation valve, the second inflation valve coupled to the chamber and operable to, when connected to a pump system, inflate the chamber to the internal air pressure, wherein the first inflation valve is adapted to receive a coupling to a low pressure pump, and wherein the second inflation valve is adapted to receive a coupling from a high pressure pump.
